(19) United States
(12) Patent Application Publication
(10) Pub. No.: US 2007/0285608 A1
(43) Pub. Date: Dec. 13, 2007

(54) Placement of spacers in a liquid crystal display panel

(75) Inventors: Hsiang-Pin Fan, Hsinchu City (TW); Ya-Chieh Chen, Hsinchu City (TW); Wei-Chieh Sun, Yonghe City (TW)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: AU Optronics Corporation

(21) Appl. No.: 11/453,189

(22) Filed: Jun. 13, 2006

(51) Int. Cl. G02F 1/1339

(52) U.S. Cl. 349/155

(57) ABSTRACT

A plurality of spacers are used to control the gap in a liquid crystal display panel. When a spacer is associated with an electrode in the lower substrate where the switching elements and data lines are disposed, it is located substantially at the center of the electrode. In a transflective LCD sub-pixel, a spacer may be disposed at the center of one of the transmissive and reflective electrodes. Alternatively, a spacer is disposed at the center of each of the transmissive and reflective electrodes. When the electrode in a sub-pixel comprises different sections to affect the alignment of the liquid crystal layer associated with the electrode, the spacer is located at the intersection of the sections, if possible, so that the spacer is located at the intersections of different domains of the liquid crystal layer.

### FIELD OF THE INVENTION

The present invention relates generally to a liquid crystal display and, more particularly, to driving the sub-pixels in the liquid crystal display.

### BACKGROUND OF THE INVENTION

As known in the art, a color liquid crystal display (LCD) panel 1 has a two-dimensional array of pixels 10, as shown in FIG. 1. Each of the pixels comprises a plurality of sub-pixels, usually in three primary colors of red (R), green (G) and blue (B). These RGB color components can be achieved by using respective color filters. FIG. 2 illustrates a plan view of the pixel structure in a conventional transmissive LCD panel. As shown in FIG. 2, a pixel 10 can be divided into three sub-pixels 12R, 12G and 12B. Each pixel is controlled by a gate line 30, and the sub-pixels 12R, 12G and 12B are controlled by data lines 21, 22 and 23, respectively. The structure of a typical transmissive LCD sub-pixel is shown in FIG. 3. As shown, the LCD sub-pixel 12 comprises a color filter layer 42 and an ITO electrode 44 disposed on an upper substrate 40. In the lower section of the LCD sub-pixel, a lower transmissive electrode 60 and a device layer 70 are disposed on a lower substrate 80. The sub-pixel 12 further comprises a liquid crystal layer 50 disposed between the upper and lower electrodes 44 and 60. The upper electrode 44 is electrically connected to a common voltage. A back-light source located behind the LCD panel is used to provide illumination. As shown in FIG. 4, the lower electrode is electrically connected to a data line m through a switching element or thin-film transistor (TFT), which is turned on by a signal on the gate line n. The common line is used for providing the common voltage to the upper electrode.

In a transflective liquid crystal display panel, as shown in FIG. 5, each sub-pixel is generally divided into a transmission area (TA) and a reflection area (RA). The transmission area has a transmissive electrode 61 and the reflection area has a reflective electrode 62. In the transmission area, light from the back-light source enters the pixel area through a lower substrate 80 and goes through the transmissive electrode 61, the liquid crystal layer 50, the color filter layer 42 and the upper substrate 40. In the reflection area, light from above the upper substrate 40 goes through the upper substrate 40, the color filter layer 42 and the liquid crystal layer 50 before it is reflected by the reflective electrode 62.

As known in the art, there are many more layers in each pixel for controlling the optical behavior of the liquid crystal layer. These layers may include one or more passivation layers disposed on the lower substrate. Various components such as storage capacitors are also disposed on the lower substrate. As it is known in the art, an LCD panel also has quarter-wave plates and polarizers. Moreover, the device layer 70 may contain a number of metal lines or areas used as gate lines, data lines, capacitors and so forth. These metal lines and areas are covered with one or more dielectric layers. The lower electrodes are usually deposited on top of the dielectric layers.

In order to achieve a liquid crystal layer of a certain thickness, spacers are generally used to control the gap between the lower and upper substrates. If the spacers are not located properly in the liquid crystal display panel, line defects may occur.

It is desirable and advantageous to provide a method for disposing the spacers in a liquid crystal display panel so as to improve the viewing quality of the display.

### SUMMARY OF THE INVENTION

The present invention uses a plurality of spacers to control the gap in a liquid crystal display panel. In particular, when a spacer is associated with an electrode in the lower substrate, it is located substantially at the center of the electrode. The lower substrate is where the TFTs, gate lines and data lines are disposed. In a transflective LCD sub-pixel, a spacer may be disposed at the center of one of the transmissive and reflective electrodes. Alternatively, a spacer is disposed at the center of each of the transmissive and reflective electrodes. When the electrode in a sub-pixel comprises different sections to affect the alignment of the liquid crystal layer associated with the electrode, the spacer is located at the intersection of the sections, if possible, so that the spacer is located at the intersections of different domains of the liquid crystal layer. Those intersections are defined as the centers of domain symmetry. As such, line defects, known as disclination, arising from singularities in the orientation order in a director field associated with the liquid crystal layer can be minimized or eliminated.

Thus, the first aspect of the present invention provides a liquid crystal display panel wherein a plurality of spacers are used to control the gap and the spacers are positioned substantially at one of the centers of domain symmetry in the sub-pixels. The second aspect of the present invention provides a method of placing and positioning the spacers in such a manner in a liquid crystal display panel.

The present invention will become apparent upon reading the description taken in conjunction with FIGS. 6 to 11b.

### BRIEF DESCRIPTION OF THE DRAWINGS

FIG. 1 is a schematic representation of a liquid crystal display panel.

FIG. 2 is a schematic representation of a pixel showing the pixel structure in a color LCD panel.

FIG. 3 is a cross sectional view of a sub-pixel showing various layers in an LCD panel.

FIG. 4 is a plan view of a sub-pixel showing a transmissive electrode in a transmissive LCD panel.

FIG. 5 is a cross sectional view of a sub-pixel in a transflective LCD panel showing a transmissive electrode and a reflective electrode.

FIG. 6 is a schematic representation of a sub-pixel in a transmissive LCD, showing the preferred location of a spacer, according to the present invention.

FIG. 7a is a schematic representation of a sub-pixel in a transflective LCD, showing the preferred location of the spacer, according to one embodiment of the present invention.

FIG. 7b is a schematic representation of a sub-pixel in a transflective LCD, showing the location of the spacer, according to another embodiment of the present invention.

FIG. 7c is a schematic representation of a sub-pixel in a transflective LCD having two spacers, according to the present invention.

FIG. 8a is a schematic representation of a pixel with three color sub-pixels wherein one spacer is disposed in each color sub-pixel.

FIG. 8b is a schematic representation of a pixel with three color sub-pixels wherein a spacer is disposed in one of the sub-pixels.

FIG. 8c is a schematic representation of a pixel with three color sub-pixels wherein spacers are disposed in two of the sub-pixels.

FIG. 9 shows the preferred location of a spacer in a sub-pixel with a strip-like electrode.

FIG. 10a shows the preferred location of a spacer in a sub-pixel wherein the liquid crystal layer in the sub-pixel is aligned differently in four domains.

FIG. 10b shows the preferred location of a spacer in a sub-pixel wherein the liquid crystal layer in the sub-pixel is aligned differently in three domains.

FIG. 10c shows the preferred location of a spacer in a sub-pixel wherein the liquid crystal layer in the sub-pixel is aligned differently in two domains.

FIG. 11a is a cross sectional view of a sub-pixel in a transflective LCD, showing the preferred location of the spacer, according to one embodiment of the present invention.

FIG. 11b is a cross sectional view of a sub-pixel in a transflective LCD, showing the location of the spacer, according to another embodiment of the present invention.

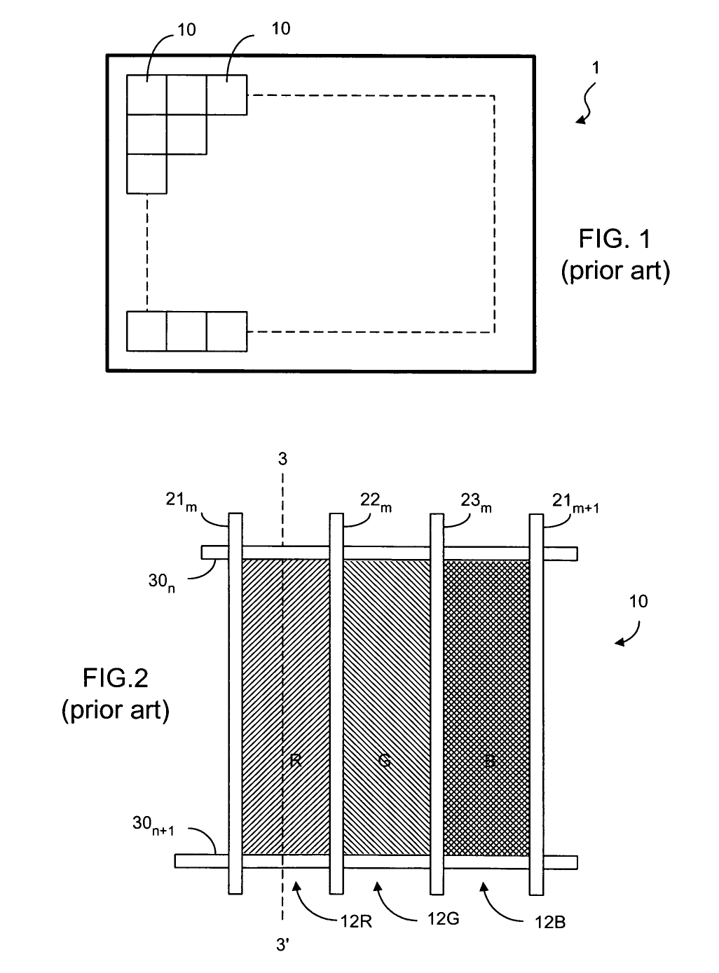

### DETAILED DESCRIPTION OF THE INVENTION

Line defects, known as disclination, may occur in a liquid crystal display. These defects arise from singularities in the orientation order in a director field associated with the liquid crystal layer. The orientation order is associated with a domain in the liquid crystal layer in a pixel or sub-pixel. The location of a spacer in the pixel or sub-pixel may enhance the line defects. In particular, when the spacers are fabricated in a photo-lithographic or photo-etching process, the location of these photo-spacers may affect the alignment of the liquid crystal molecules around the photo-spacers. Certain misalignment produces disclination lines and affects the view quality of the LCD panel. For example, the disclination lines may give rise to a defect known as image retention.

The present invention provides a way of placing the photo-spacers in an LCD panel so that the occurrence of disclination lines can be reduced or eliminated. It should be noted that, in an LCD panel having a 2-dimentional array of pixels, it may not be necessary that each of the pixels will have a spacer disposed therein. However, when a pixel has one or more spacers disposed therein, each spacer is located at a center of symmetry of the electrode associated with that spacer.

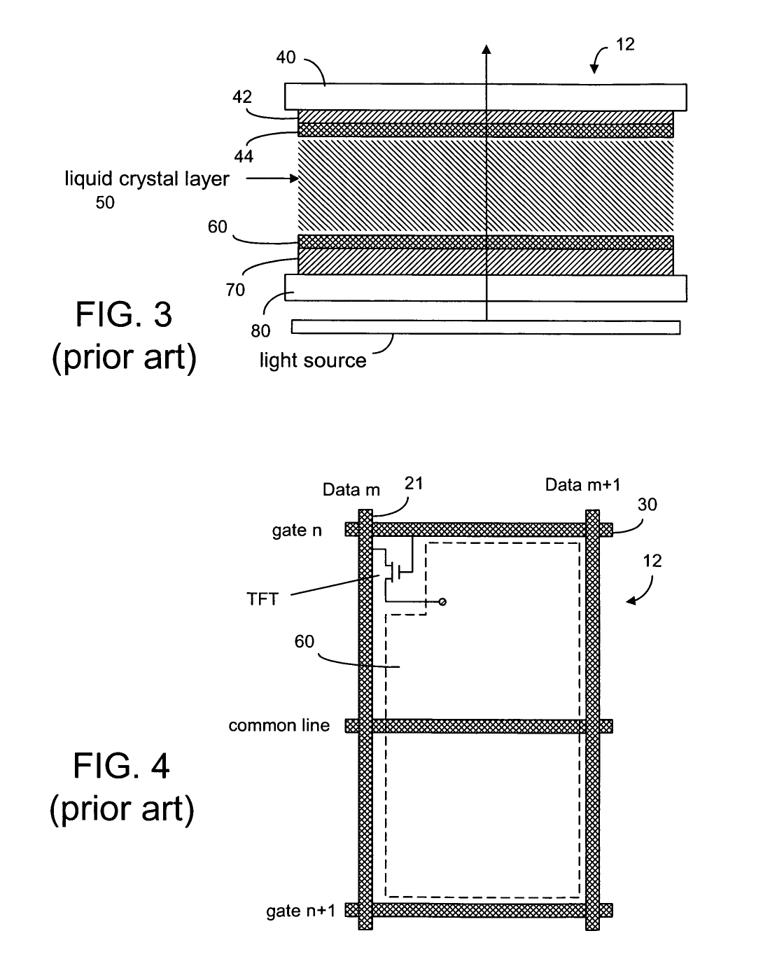

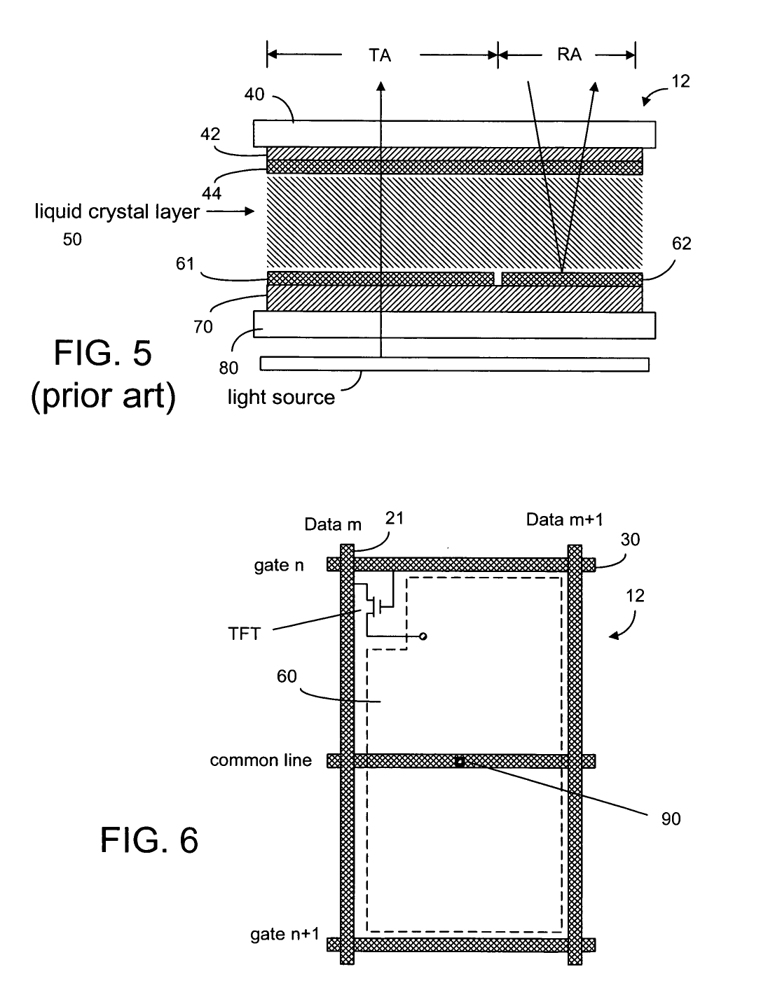

In a sub-pixel that has only one lower electrode to control the alignment of the liquid crystal layer in that sub-pixel, the spacer is located substantially at the center of the electrode. As shown in FIG. 6, only one lower electrode 60 is used, together with the upper electrode (see FIG. 3), to control the liquid crystal layer in the sub-pixel 12. The lower electrode 60 is operatively connected to a data line via a TFT, which is controlled by a gate line. The TFT, the gate line and the data line are generally fabricated in the device layer 70 and the electrode 60 is disposed on top of the device layer (see FIG. 3). The electrode 60 is made of an optically transparent, electrically conductive material such as indium tin-oxide (ITO). In this case, a spacer 90 is disposed substantially at the center of the lower electrode 60.

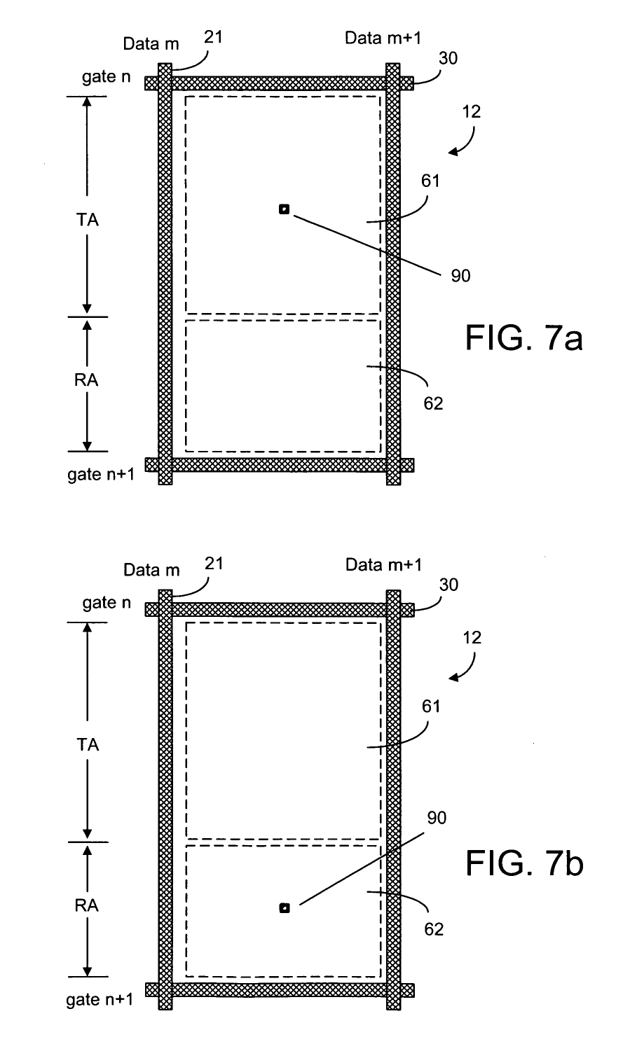

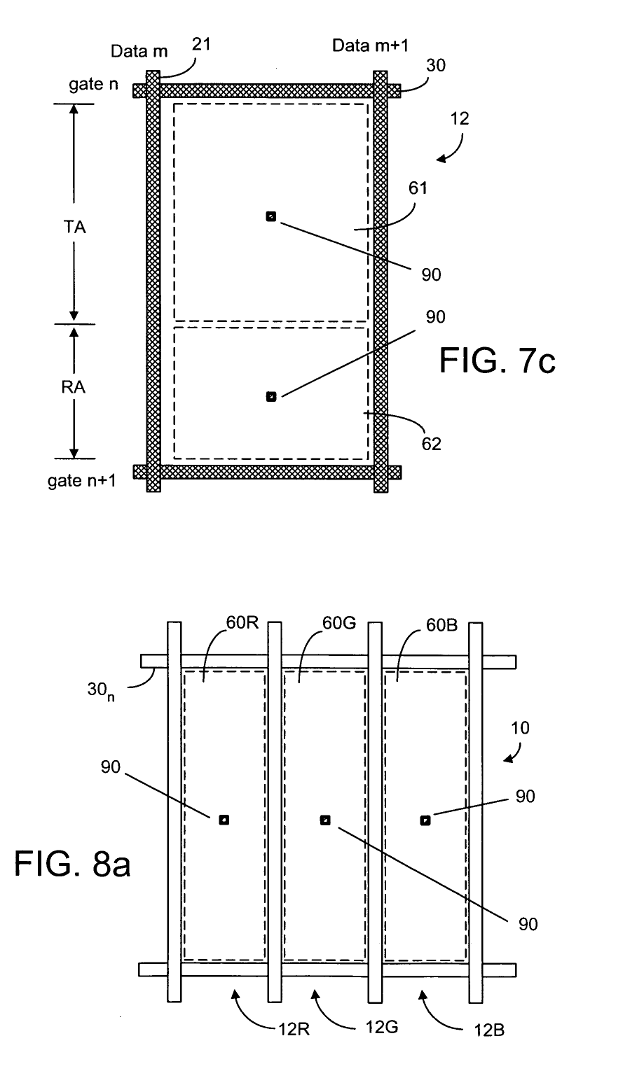

In a sub-pixel having two lower electrodes to separately control the alignment of the liquid crystal layer in that sub-pixel, one or two spacers may be used. FIGS. 7a to 7c illustrate a typical sub-pixel in a transflective LCD panel, wherein electrode 61 is a transmissive electrode and electrode 62 is a reflective electrode. The reflective electrode is usually made of an reflective metal, such as aluminum. If one spacer is used in the sub-pixel 12 having lower electrodes 61 and 62, the spacer 90 can be located at the center of the transmissive electrode 61, as shown in FIG. 7a. Alternatively, the spacer 90 can be located at the center of the reflective electrode 62, as shown in FIG. 7b. If two spacers are used, then one spacer is located at the center of the transmissive electrode 61 and the other spacer is located at the center of the reflective electrode 62, as shown in FIG. 7c.

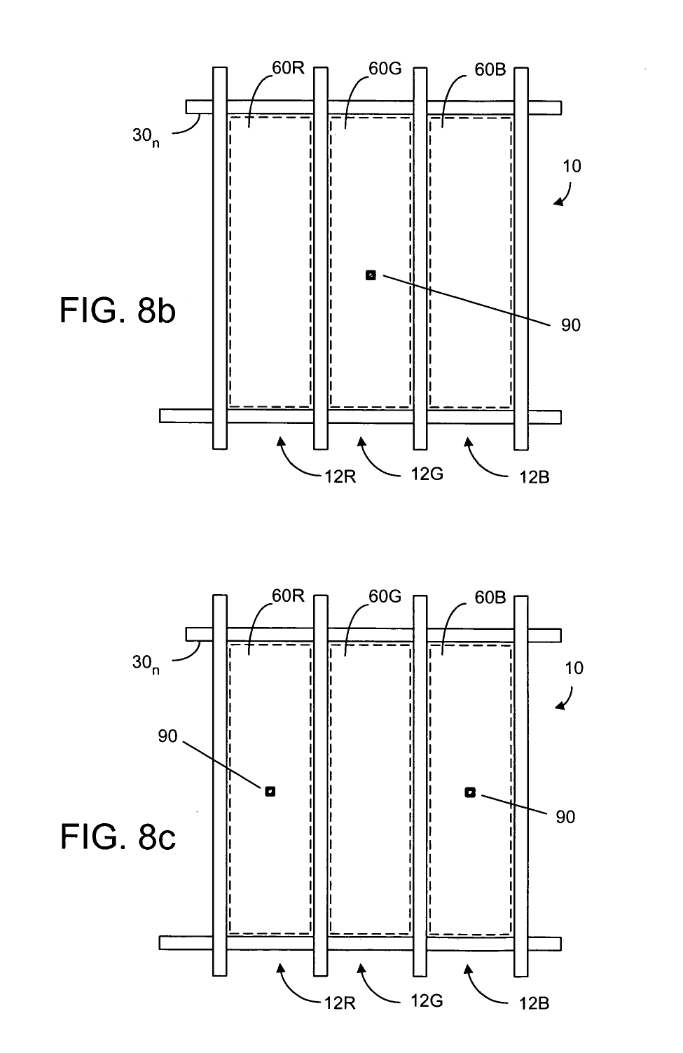

In a pixel 10 with a plurality of color sub-pixels 12, as shown in FIGS. 8a to 8c, each sub-pixel 12 has a separate lower electrode 60. One or more spacers can be used. If three spacers are used in the pixel 10, as shown in FIG. 8a, it is preferred that each spacer 90 is located at the center of a different electrode 60. If only one spacer 90 is used, then it can located at the center of one of the electrodes 60, as shown in FIG. 8b. If two spacers 90 are used, then the spacers are separately located at any two of the sub-pixels 12, with each spacer 90 being located at the center of one lower electrode 60, as shown in FIG. 8c.

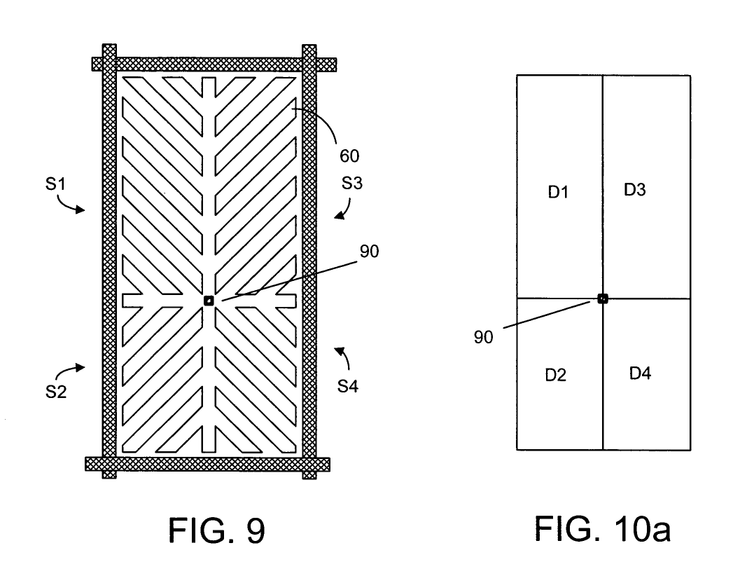

In a pixel or sub-pixel where a strip-like electrode is used to affect the alignment of the liquid crystal layer above the electrode, as shown in FIG. 9, one electrode is effectively divided into four electrically connecting sections S1, S2, S3 and S4, with the orientation of the strips in one section being different from that in the adjacent section. As such, it is possible that the alignment orientation of the liquid crystal layer in S1 and S4 is different from that in S2 and S3. In this type of LCD, it is preferred that the spacer 90 is located at the common corner of the four sections.

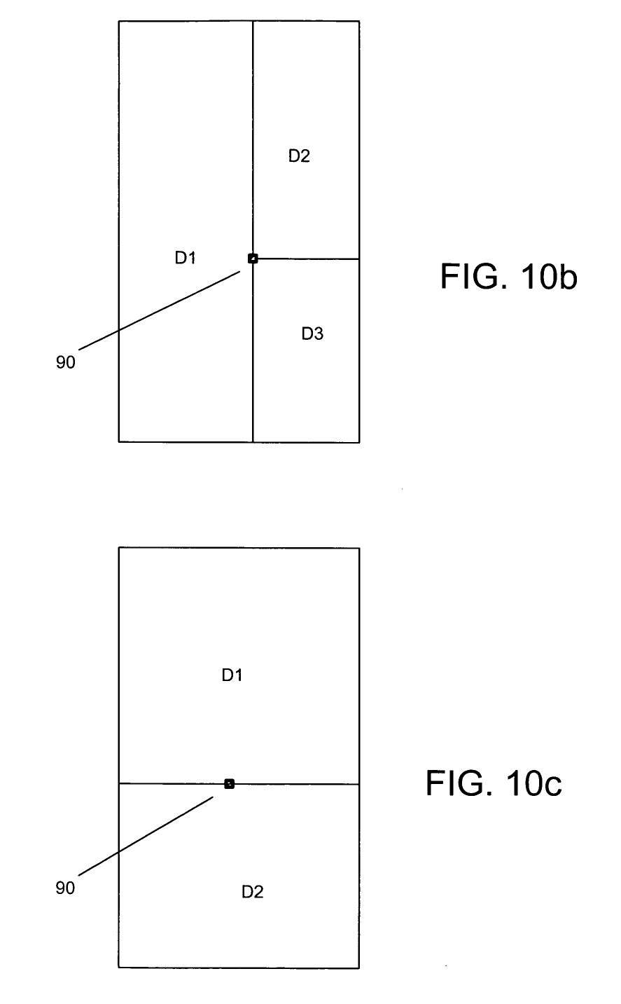

It should be noted that, although only one strip-like electrode is used to control the liquid crystal layer in a sub-pixel or pixel, the spacer is not necessarily located at the center of electrode such as that shown in FIG. 6. In the sub-pixel as shown in FIG. 6, it is likely that the liquid crystal layer associated with the lower electrode has substantially one alignment orientation. In such as case, the liquid crystal layer associated with the lower electrode 60 is said to have only one domain. However, in the sub-pixel as shown in FIG. 9, the liquid crystal layer associated with the lower electrode 60 is likely to have four domains, each in a different section. The domains are shown in FIG. 10a. As shown in FIG. 10a, domains D1, D2, D3 and D4 are corresponding to sections S1, S2, S3 and S4 of FIG. 9.

When the liquid crystal layer in a sub-pixel or pixel has more than one joining domain, it is preferred that a spacer is placed at the center of symmetry of the domains. For example, in a sub-pixel having four domains D1, D2, D3 and D4 as shown in FIG. 10a, the center of symmetry of the domains is defined as the joining point of the four domains. In a sub-pixel having three domains D1, D2 and D3 as shown in FIG 10b, the center of symmetry of the domains is defined as the point shared by all three domains. In a sub-pixel having two domains D1 and D2 as shown in FIG. 10c, the center of symmetry of the domains is defined as the center of the borderline of the two domains.

In FIG. 6, it is likely that only one liquid crystal domain is associated with the lower electrode 60. Thus, the center of symmetry of the domain is the same as the center of the lower electrode. In FIGS. 7a to 7c, the alignment orientation of the liquid crystal layer associated with the lower electrode 61 and that associated with the lower electrode 62 may be the same or different. Thus, the liquid crystal layer in the same sub-pixel 12 may have two domains. However, these domains are said to be non-joining because the electrodes 61 and 62 are electrically separate. Thus, each domain has its own center of symmetry.

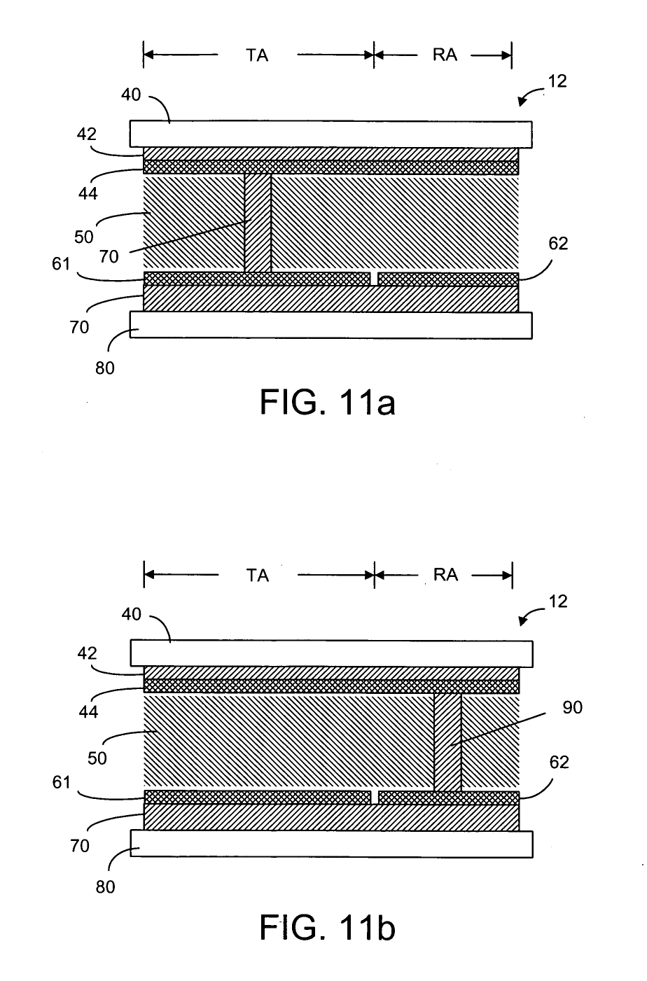

FIG. 11a is a cross sectional view of a sub-pixel in the transflective LCD of FIG. 7a, showing the preferred location of the spacer, according to one embodiment of the present invention. FIG. 11b is a cross sectional view of a sub-pixel in a transflective LCD of FIG. 7b, showing the location of the spacer, according to another embodiment of the present invention. As shown in FIG. 11a, the spacer 90 is disposed between the upper electrode 44 and the lower transmissive electrode 61. The spacer 90 is positioned substantially at the center of the electrode 61. The spacer 90 may or may not contact the upper electrode 44. As shown in FIG. 11b, the spacer 90 is disposed between the upper electrode 44 and the lower reflective electrode 62. The spacer 90 is positioned substantially at the center of the electrode 62. The spacer 90 may or may not contact the upper electrode 44.

Preferably, the spacer 90 is made of a photo-resist material and produced in a photo etching process. It is possible to dispose a black masking material in the color filter layer 42 above the spacer 90.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for providing a gap in a liquid crystal display panel having a plurality of pixels, at least some of the pixels having a plurality of sub-pixels, said method comprising:, said method comprising:
disposing a spacer at least in some of the sub-pixels to define the gap in the liquid crystal display panel, the display panel comprising a first substrate, a second substrate, a first electrode layer disposed on the first substrate, a second electrode layer disposed on the second substrate, and a liquid crystal layer disposed in the gap between the first electrode layer and the second electrode layer, wherein each sub-pixel has a first electrode in the first electrode layer and one or more second electrodes in the second electrode layer to control alignment of the liquid crystal layer in the sub-pixel, and wherein said one or more second electrodes in the second electrode layer together with the first electrode in the first electrode layer cause the liquid crystal layer in the sub-pixel to align substantially in one or more domains, and said one or more domains have one or more centers of domain symmetry, and
positioning the spacer at least substantially at one of the centers of the domain symmetry.

2. The method of claim 1, wherein said one or more domains have substantially only a single domain, and said one or more centers of domain symmetry has only one center located substantially at a center of said single domain, and wherein the spacer is positioned substantially at the center of said single domain.

3. The method of claim 1, wherein said one or more domains comprise two or more separate domains, and said one or more centers of domain symmetry comprise a plurality of centers, each located substantially at a center of each of said separate domains, and wherein the spacer is positioned substantially at the center of one of said separate domains.

4. The method of claim 1, wherein said one or more domains comprise at least one cluster of joining domains, and said one or more centers of domain symmetry comprise one center of domain symmetry for said one cluster of joining domains for said positioning.

5. The method of claim 1, wherein the center of domain symmetry for said one cluster of joining domains is located substantially at an intersection of the joining domains.

6. The method of claim 4, wherein said one or more domains further comprise at least one separate domain.

7. The method of claim 1, wherein said one or more domains comprise at least one separate domain and at least one cluster of joining domains, and said one or more centers of domain symmetry comprises a domain center located substantially at a center of said separate domain for said positioning.

8. The method of claim 1, wherein said one or more second electrodes in the sub-pixel comprise a transmissive electrode and a reflective electrode, and wherein said spacer is positioned substantially at the center of the transmissive electrode.

9. The method of claim 1, wherein said one or more second electrodes in the sub-pixel comprise a transmissive electrode and a reflective electrode, and wherein said spacer is positioned substantially at the center of the reflective electrode.

10. The method of claim 9, further comprising a further spacer located substantially at the center of the transmissive electrode.

11. The method of claim 1, wherein the spacer is made of a photo-resist material.

12. A liquid crystal display panel comprising:
a first substrate,
a second substrate,
a first electrode layer disposed on the first substrate,
a second electrode layer disposed on the second substrate,
a liquid crystal layer disposed in a gap between the first electrode layer and the second electrode layer, defining a plurality of pixels, wherein at least some of the pixels have a plurality of sub-pixels, each sub-pixel having a first electrode in the first electrode layer and one or more second electrodes in the second electrode layer to control alignment of the liquid crystal layer in the sub-pixel, and
a plurality of spacers disposed at least in some of the sub-pixels to define the gap between the first electrode layer and the second electrode layer, wherein said one or more second electrodes in the second electrode layer together with the first electrode in the first electrode layer in each of said some sub-pixels cause the liquid crystal layer in the sub-pixel to align substantially in one or more domains, and wherein one of said plurality of spacers is located substantially at a center of symmetry of said one or more domains.

13. The liquid crystal display panel of claim 12, wherein said one or more domains comprise at least a cluster of joining domains, and wherein said center of symmetry is located at an intersection of the joining domains.

14. The liquid crystal display panel of claim 12, wherein one or more second electrodes comprise a transmissive electrode, and wherein said one spacer is located substantially at a center of the transmissive electrode.

15. The liquid crystal display panel of claim 12, wherein said one or more second electrodes comprise a transmissive electrode and a reflective electrode, and wherein said one spacer is located substantially at a center of the transmissive electrode.

16. The liquid crystal display panel of claim 12, wherein said one or more second electrodes comprises a transmissive electrode and a reflective electrode, and wherein said one spacer is located substantially at a center of the reflective electrode.

17. The liquid crystal display panel of claim 16, further comprising a further spacer in each said sub-pixel disposed substantially at a center of the transmissive electrode.

18. The liquid crystal display panel of claim 12, wherein the spacers are made of a photo-resist material.
